(19) United States
(12) Patent Application Publication
(10) Pub. No.: US 2021/0293529 A1
(43) Pub. Date: Sep. 23, 2021

(54) SYSTEM AND METHOD FOR CALCULATING THICKNESS OF MARKING MATERIAL APPLIED TO A ROADWAY SURFACE

(71) Applicant: EPIC Solutions, Inc., Fargo, ND (US)

(72) Inventors: Jeffrey Arnold Wilkens, West Fargo, ND (US); Reise Stenberg, Argusville, ND (US)

(21) Appl. No.: 17/204,658

(22) Filed: Mar. 17, 2021

Related U.S. Application Data
(60) Provisional application No. 62/990,690, filed on Mar. 17, 2020.

(51) Int. Cl. G01B 11/06; G01S 17/08; E01C 23/22; B60K 35/00

(52) U.S. Cl. CPC G01B 11/0616; G01S 17/08; B60K 2370/11; B60K 35/00; B60K 2370/152; E01C 23/22

(57) ABSTRACT

A system and method (i.e., utilities) for calculating, in substantially real-time, the thickness of marking materials applied to roadway surfaces. The utilities utilize a linear position sensor to monitor positions of a shaft of a positive displacement paint pump. By monitoring the shaft position multiple times per stroke of the pump, pump displacement volumes may be calculated for intra-stroke movements of the pump. The pump displacement volumes permit calculating applied thickness of the marking materials in finer temporal increments than was previously possible.

### CROSS REFERENCE

The present application claims the benefit of the filing date of U.S. Provisional Application No. 62/990,690 having a filing date of Mar. 17, 2020, the entire contents of which is incorporated herein by reference.

### FIELD

The present disclosure relates to roadway marking. More particularly, the disclosure relates to the substantially real-time monitoring of thicknesses of marking materials (e.g., paint) applied to a roadway surfaces.

### BACKGROUND

Roadways commonly have lines or intermittent stripes painted on their surface to guide traffic. A pavement marking material such as, for example, conventional paint, epoxy, or thermoplastic (referred to herein generally as “paint”) is used to create visible stripe paint line. Glass beads may be applied to the freshly painted surface immediately after the pavement marking material is applied. The glass beads serve to make the stripes or lines more visible because they reflect light, such as from a vehicle's headlights.

For street and highway applications, a flatbed truck is typically configured to carry all the necessary supplies and equipment so that pavement marking material and, if utilized, beads can be applied to the road surface in an economical fashion. A typical truck used to apply beads and pavement marking materials, referred to herein as a paint truck, has two pavement marking material tanks and one bead tank. In operation, paint trucks may travel as fast as 25 mph while painting continuous or intermittent paint lines on the road surface.

In most systems, the marking material is pumped using a high pressure positive displacement pump, which pushes the material through a small opening/orifice(s) of the nozzles of one or more paint/spray gun(s). This creates a line on the roadway. A specific amount of paint and beads is usually required per foot to meet various specifications (e.g., state highway requirements). For example, such a specification may require that 300 lineal feet of a 4 inch wide paint line utilize a gallon of paint and, if utilized, 6 lbs. of beads. Stated otherwise, the paint line typically has a required thickness (i.e., ‘mil thickness’) as applied to the roadway. Accordingly, it is desirable to monitor the amount of material applied in order to comply with mil thickness specifications and/or to avoid over application (e.g., waste).

Operators often rely on little more than visual inspection, intuition and experience to know how much or how little material they are putting down (e.g., the applied mil thickness). Beyond experience and intuition, certain devices and methods exist in the prior art for estimating the mil thickness of an applied line. One method entails utilizing a stroke counter that counts the number of strokes of a positive displacement pump that supplies marking material to spray guns. As the pump has a known displacement volume per stroke, the number of strokes times the known volume displacement volume is divided into the number of lineal feet painted since the last calculation. While providing an adequate estimate when paint is applied in long stretches utilizing multiple pump strokes, such a methodology is less effective in shorter applications. Of note, positive displacement pumps utilized for marking applications typically displace one-half gallon or one gallon per stroke. Short application distances may utilize less volume than is supplied by a single stroke of the positive displacement pump. In these and other situations, no feedback may be available regarding the applied thickness of the paint.

It would be desirable to accurately monitor the amount of paint being applied in substantially real-time to allow operator to make more immediate adjustments necessary to meet desired specifications.

### SUMMARY

The present invention allows the real time or near-real time monitoring of paint usage. The disclosed systems and methods (i.e., utilities) allow for monitoring paint usage by measuring the shaft position of a reciprocating-shaft positive displacement pump that supplies paint to one or more spray guns. The position of the shaft may be monitored/measured numerous times per stroke (e.g., once per second or more frequently). The change in shaft position between any two measurements may be used to calculate the volume of paint displaced by the pump. Notably, this allows for calculating displacement of less than a single pump stroke. Such displacement information along with additional information (e.g., distance traveled, line width, spray nozzle diameter(s), etc.) permits calculating the thickness of the paint applied to a surface. Further, the ability to measure position multiple times per minute (e.g., once per second) permits near instant calculation of paint thickness as applied. That is, paint thickness may be calculated in substantially real-time.

In one aspect, a system and method (e.g., utility) monitors the thickness of paint applied to a surface. The utility includes a reciprocating-shaft positive displacement pump that pumps paint from a paint supply to one or more paint guns (e.g., spray guns/nozzles). A linear position sensor fixedly attached relative to the pump monitors/measures the position of the pump shaft at a predetermined rate (e.g., once per second). A controller (e.g., processor) receives the output (shaft position measurement) of the linear position sensor. The position of the shaft may be stored to memory. The controller also receives an output from a speed and/or distance sensor attached to a vehicle supporting the pump and paint gun(s). Such a vehicle may be a self-propelled paint truck or manually propelled cart. The speed/distance sensor provides an output indicative of a travel speed of the vehicle and/or a distance traveled by the vehicle. The controller utilizes at least two shaft position measurements and one or more outputs of the speed or distance sensor to calculate a thickness of the paint applied to a surface over which the vehicle is traveling. Further, the processor may access additional information relating to orifice outlet size of the paint gun(s) and/or other stored information. That is, the controller may access stored data stored on computer readable media and/or receive user inputs. Such data and/or user inputs may provide data associated with, for instance, orifice size of the paint guns and paint type. In one arrangement, a line thickness output from the controller is displayed on a user display allowing a user to alter line thickness as needed (e.g., modify the speed of the pump). In another arrangement, the output is provided to a controller that automatically controls pump speed. In this arrangement, the speed of the pump may be automatically controlled to maintain the line thickness within a desired range. In one arrangement, the linear position sensor is a laser distance sensor. In another arrangement, the linear position sensor is a mechanical sensor.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

For a more complete understanding of the present disclosure and further advantages thereof, reference is now made to the following detailed description taken in conjunction with the drawings in which:

FIG. 1 illustrates one embodiment of a line painting truck.

FIGS. 2A and 2B illustrates one embodiment of a reciprocating shaft displacement pump.

FIG. 2C illustrate the reciprocating shaft displacement pump coupled to a linear shaft hydraulic pump.

FIGS. 3A-3C illustrate measuring a shaft position of the reciprocating displacement pump using a laser distance sensor.

FIGS. 3D-3F illustrate measuring a shaft position of the reciprocating displacement pump using a mechanical distance sensor.

FIG. 4 illustrates a schematic representation of an overall system.

### DETAILED DESCRIPTION

Reference will now be made to the accompanying drawings, which at least assist in illustrating the various pertinent features of the presented inventions. Though discussed primarily in relation to monitoring the application thickness of roadway marking materials applied by a self-propelled paint truck, it will be appreciated that the present disclosure is not so limited. By way of example, the systems and methods described herein may be utilized with any roadway marking application system including manually propelled carts. As such, the term ‘paint vehicle’ as used herein is meant to include any self-propelled or manually propelled paint application system. The following description is presented for purposes of illustration and description. Furthermore, the description is not intended to limit the disclosed embodiments of the inventions to the forms disclosed herein. Consequently, variations and modifications commensurate with the following teachings, and skill and knowledge of the relevant art, are within the scope of the presented inventions.

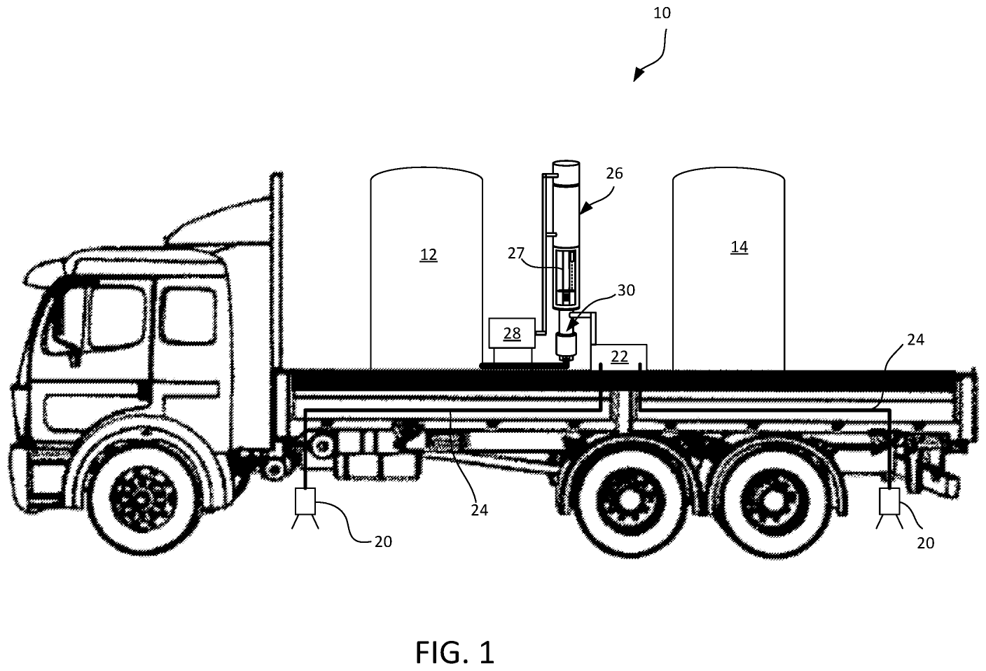

FIG. 1 illustrates one exemplary embodiment of a simplified paint truck. As shown, the paint truck 10 includes a paint tank 12 that holds a supply of convention paint or thermoplastic paint. In the latter regard, the truck may include a furnace (not shown) for melting solid thermoplastic feed stock and various gas sources (e.g., propane tanks; not shown), which the furnace uses to heat the thermoplastic feed stock in the paint tank. A second tank 14 for holding another supply of paint or beads is also illustrated. As shown, an outlet of the paint tank 12 is connected to an inlet of a reciprocating shaft displacement pump 30 (not to scale). This pump 30 (hereafter paint pump) is operative to pump paint from the paint tank 12 through nozzles (not shown) of one or more paint guns 20 via a paint manifold 22 and various supply lines 24. As will be appreciated, the truck may include multiple paint pumps for use with different paint tanks.

In the illustrated embodiment, the paint pump 30 is connected to a linear hydraulic actuator 26 that is connected to a hydraulic supply 28. That is, the linear hydraulic actuator 26 connects to a supply of hydraulic fluid (i.e., hydraulic supply 28) pressurized by a supply pump (not shown) via hydraulic supply lines. In operation, the hydraulic supply pump supplies hydraulic fluid pressure to the linear hydraulic actuator 26 resulting in a shaft 27 of the actuator 26 reciprocating. The shaft 27 of the hydraulic actuator connects to a shaft of the paint pump. The reciprocating motion of the shaft 27 of the hydraulic actuator 26 moves the shaft of the paint pump 30 up and down resulting in the paint pump 30 drawing paint into its housing and (e.g., during a first upward stroke) and discharging that component under pressure on another stroke (e.g., during a second downward).

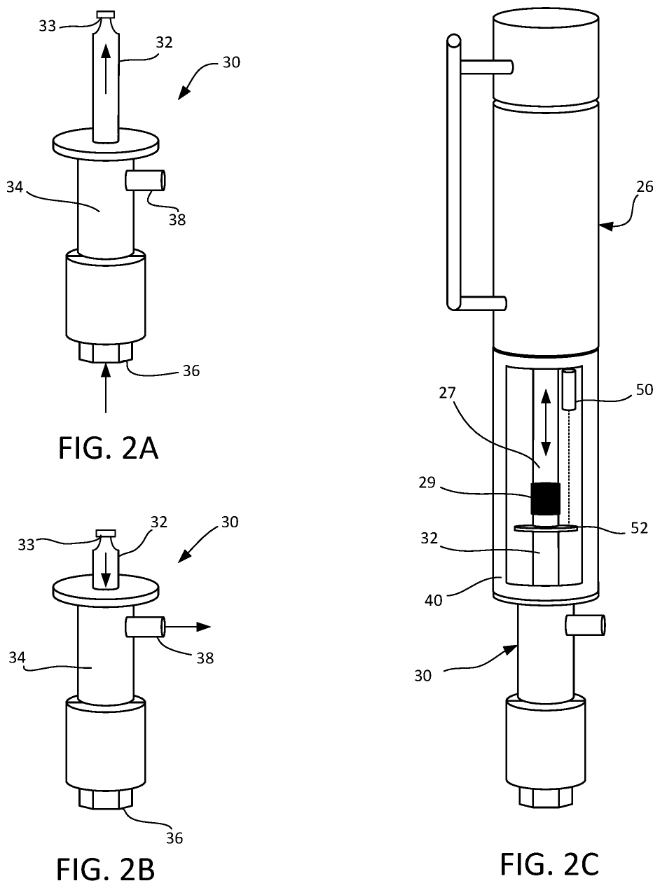

FIGS. 2A and 2B illustrate one embodiment of a reciprocating shaft displacement paint pump 30 that may be utilized with the paint application system illustrated in FIG. 1 as well as other paint application systems. As shown, the paint pump 30 includes a shaft 32 that connects to a plunger or piston (not shown) disposed within a generally cylindrical housing 34. During operation, the shaft 32 moves upward (FIG. 2A) to draw material into an inlet 36 of the housing 34. When the direction of the shaft reverses and moves downward (FIG. 2B), a check valve (not shown) in the housing closes and the material in the housing is expelled under pressure out of an outlet 38 of the pump housing 34. One exemplary reciprocating shaft displacement pump is the Model 287834 Displacement Pump manufactured by Graco Inc. of Minneapolis Minn. However, it will be appreciated that the present disclosure is not limited to any specific pump type or manufacturer. Though illustrated as a single action reciprocating pump that draws and displaces on separate strokes (e.g., upward stroke and downward stroke), it will be appreciated that the positive displacement pump may be a dual action pump that draws and displaces paint on each stroke.

FIG. 2C illustrates the paint pump 30 as connected to a linear hydraulic actuator 26. As shown, a collar 33 (See FIGS. 2A and 2B) on the shaft 32 of the paint pump connects to a shaft 27 of the linear hydraulic actuator 26 via a connector 29. The linear hydraulic actuator 26 and the paint pump 30 are also connected by a yoke housing 40 that connects to flanges of the actuator 30 and pump 30 and aligns the shafts 27, 32 of the actuator and pump. Once connected, the reciprocating motion provided by the hydraulic actuator 26 (e.g., hydraulic drive) transfers to the paint pump 30, which pumps paint (or other material) from a supply tank to one or more spay guns. One exemplary hydraulic drive and connected displacement pump is the RPS 2900 OEM Kit manufactured by Graco Inc. of Minneapolis Minn. However, it will be appreciated that the present disclosure is not limited to any specific pump type or manufacturer.

As previously discussed, when applying roadway markings it is often desirable to apply the markings to a roadway surface with a specific thickness (here after mil thickness) to comply with various specifications. Previous systems utilized to calculate mil thickness of applied marking material utilize a stroke counter that counts the number of strokes of the positive displacement pump supplying marking material to spray guns. As the pump has a known displacement volume per stroke, the number of strokes times the known pump displacement volume is divided into the number of lineal feet painted since the last calculation. While providing an adequate estimate when paint is applied in long stretches, such a methodology is less effective in shorter applications. That is, positive displacement pumps utilized for marking applications typically displace one-half gallon or one gallon per stroke. Short application distances may utilize less volume than is supplied by a single stroke of the positive displacement pump. In these and other situations, no feedback may be available regarding the applied thickness of the paint. Stated otherwise, prior systems that utilize stroke counting arrangements fail to provide granularity for short distance mil thickness calculations and for low application rate mil thickness calculations. By way of example, when marking a single skipped centerline, the travel distance of a marking vehicle may be hundreds of feet or even a quarter of a mile during a single pump stroke. A significant amount of marking material may be applied prior to obtaining any usable information regarding applied marking thickness. In general, prior systems fail to provide substantially real-time mil thickness information that allows an operator the ability to readily adjust the thickness of markings during application.

The presented system overcomes the drawbacks of prior systems by providing a monitoring system or sensor that monitors the linear position of the shaft of a reciprocating shaft displacement paint pump in substantially real time. As utilized herein, substantially real time is meant to include monitoring shaft position multiple times per minute. For example, monitoring shaft position every 10 seconds, every 5 second or even once per second. Finer measurement periods are possible. The ability to monitor the position of the displacement shaft in real-time permits calculating the volume of material (e.g., paint) displaced in less than a full stroke of the displacement pump allowing an operator or an automated controller the ability to readily adjust the mil thickness of applied markings as needed.

FIG. 2C illustrates one embodiment of a shaft position monitoring system in accordance with the presented disclosure. As illustrated, a linear distance sensor 50 is attached proximate to the paint pump 30. In this embodiment, the linear distance sensor 50 is laser distance sensor that is mounted to the yoke 40, which connects the linear hydraulic actuator 26 and the paint pump 30. A reflector plate or sensor collar 52 is attached to the shaft 32 of the pump 30. Alternatively, the reflector plate could be attached to the shaft of the linear hydraulic actuator. A non-limiting example of a laser position sensor is the QX4 Stainless Steel Analog Laser Sensor available from Banner Engineering Corp. of Plymouth, Minn. However, it will be appreciated that the present disclosure is not limited to any specific laser distance sensor or manufacturer.

In operation, the laser distance sensor 50 emits a laser 54 that is directed to the sensor collar 52. At least a portion of the laser is reflected back to the laser distance sensor, which calculates a distance between the sensor 50 and the sensor collar 52. Such calculation is typically based on time of flight principles as known by those skilled in the art of laser distance sensors. The sensor 50 may generate an output for each measurement. Such an output may include a distance and time that the measurement was taken. Such outputs may be received by a controller.

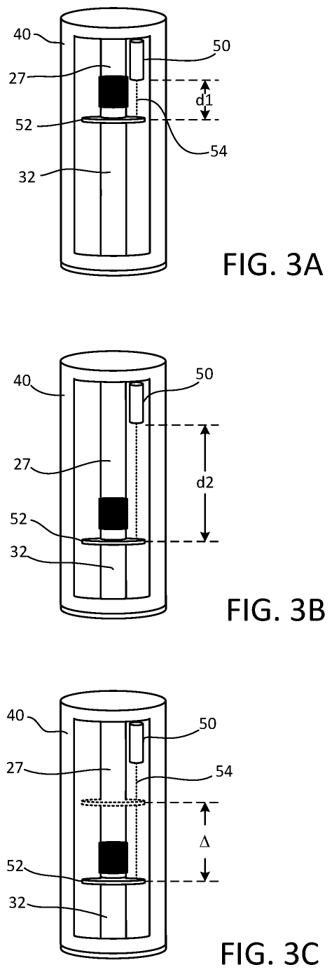

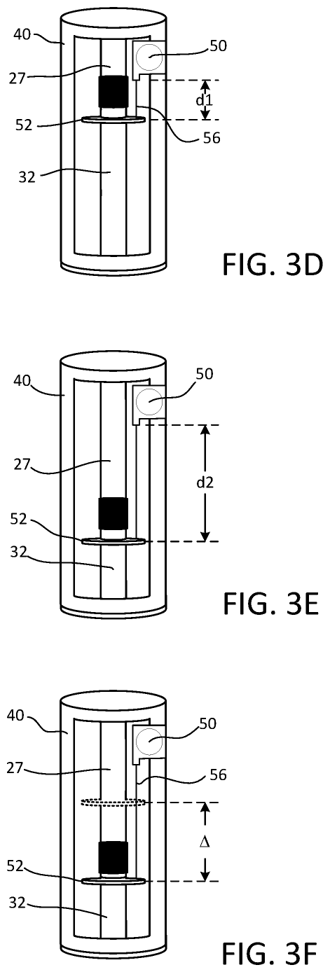

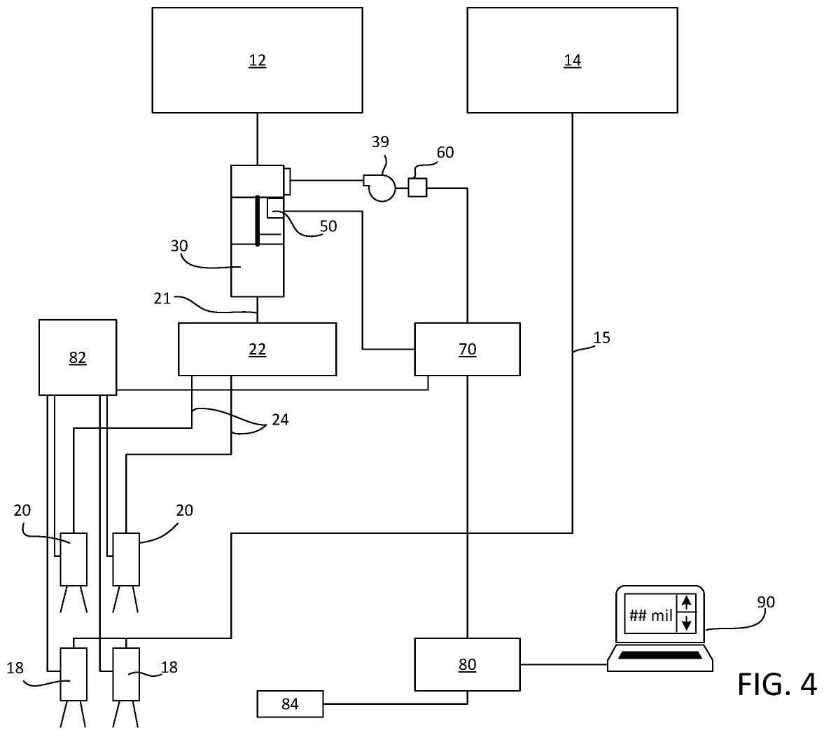

FIGS. 3A-3C illustrate measuring an intra-stroke positions of a displacement pump utilizing the laser distance sensor. These figures correspond to the embodiment of FIG. 2C showing the yoke 40 connecting the shaft 32 of the displacement pump 30 to the shaft 27 of the linear hydraulic actuator 26. As illustrated in FIGS. 3A-3C, the actuator and the pump are omitted for purposes of illustration. As shown, the sensor 50 takes a first measurement at a first time t₁ when the paint pump shaft 32 is a first distance d₁ from the sensor 50. See FIG. 3A. The sensor 50 takes a second measurement at a second time t₂ when the paint pump shaft 32 is a second distance d₂ from the sensor 50. See FIG. 3B. Utilizing the two measurements, a controller is operative to find a displacement Δ between the first and second measurements. Multiplying the displacement with a known internal area of the pump (e.g., piston area) produces a total volume of material displaced between the two measurements (i.e., between t₁ and t₂). Such a volume may be utilized by a controller to calculate the mil thickness of material as applied to a surface (e.g., roadway surface).

FIGS. 3D-3F illustrate an alternate embodiment of a system for measuring an intra-stroke positions of a displacement pump utilizing a mechanical linear distance sensor 50. The system of FIGS. 3D-3F is substantially similar to the system of FIGS. 3A-3C and like reference numbers are utilized for like elements. As illustrated, the linear distance sensor 50 is linear encoder reel sensor that has a retractable cable 56 that extends from and retracts into a housing/reel of the sensor 50. One exemplary linear encoder reel sensor is the SK6 Cable Actuated Encoder Reel available from TE Connectivity Company of Schaffhausen, Switzerland. However, it will be appreciated that other encoders may be utilized. As illustrated, the cable 56 connects to the sensor collar 52 connects to the shaft 32 of the pump. Other points of connection are possible. The sensor 50 is operative to generate outputs based on the extension/retraction of the cord 52 relative to the sensor housing. As above, the sensor 50 takes a first measurement at a first time t₁ when the paint pump shaft 32 is a first distance d₁ from the sensor 50. See FIG. 3D. The sensor 50 takes a second measurement at a second time t₂ when the paint pump shaft 32 is a second distance d₂ from the sensor 50. See FIG. 3E. Utilizing the two measurements, a controller is operative to find a displacement Δ between the first and second measurements. See FIG. 3F. Though discussed herein as utilizing either a laser or an encoder reel as the linear distance sensor, other linear distance sensors may be utilized. Such linear distance sensors include, without limitation, capacitive, inductive and/or magnetic sensor to name a few.

Based, in part, on the linear distance sensor outputs, a mil thickness may be calculated utilizing the following exemplary equation:

$$Mils = \frac{k * Gallons Used}{( Distance in feet ) * ( Width in Inches )} * 0.001$$

Initially, the total volume of material utilized between two measurements may be converted into gallons (i.e., gallons used). The distance traveled between measurements may be provided by a distance sensor that measures actual distance travelled between the two measurements or may be calculated using an average vehicle speed over the time span between measurements. If the time span is short enough (e.g., one second), a single vehicle speed may be assumed to be constant for the time span. The width of the applied line may be set by a user. A constant k may account for variables in the system including, without limitation, the type of line applied (e.g., single solid, double solid, single skipped, etc.) the number of spay guns applying paint and/or the orifice(s) spraying the paint. As will be appreciated, different constant values may be utilized for different applications. Such information may be stored by a system controller.

An embodiment of a system incorporating the real-time position measurement of a displacement pump is shown schematically in FIG. 4. As shown, the system includes a paint tank 12 and a bead tank 14. As shown the paint pump 30 draws paint from the paint tank 12 pressurizing the paint to flow through a supply line 21 to a collection manifold 22. The paint flows from the collection manifold through second supply line(s) 24 to one or more paint gun 20, where the paint is applied to the road surface when the paint guns are opened. Beads flow out of the bead tank 14 through supply lines 15 to one or more bead guns 18, where the beads are applied to the paint as applied road surface.

The linear position sensor 50 monitors the position of the reciprocating shaft of the paint pump 30. Further, a hydraulic pump sensor 60 monitors the speed (e.g., rpm) of the hydraulic supply pump 39, which provides hydraulic pressure to the linear hydraulic actuator 26 and controls the speed of the hydraulic actuator. Output signals from these sensors 50, 60 are transmitted to a data communications box 70. Alternately, such signals may be provided directly to a processor/controller 80. In addition to the distance and speed sensors, the system may include one or more pressure sensors (not shown) may be used to monitor the pressure of the various paint lines. Temperatures of the marking material may also be monitored by one or more temperature sensors (not shown). Outputs of any such sensors may be provided to the communications box 70 and/or the controller 80.

A timer box 82 controls the opening and closing of the paint and bead guns. By way of example, the timer box may open and close the guns to generate a skip line on a roadway surface. The timer box may receive timing information from the controller 80 or directly from a vehicle displacement sensor 84. The sensor 84 may be any sensor that generates an output indicative of the speed of the vehicle and/or a distance traveled by the vehicle for a given time period. Such sensors include, without limitation, wheel speed sensors, transmission speed sensors, optical sensors and Hall Effect sensors to name a few.

The controller may include a PLC or microprocessor and typically incorporates computer readable storage media (not shown). In the illustrated embodiment, the communication box 70 transmits communications between the controller 80 and the various sensors and controllers (e.g., timer box). The controller 80 may be programmed with instructions to display data on a peripheral device such as a monitor or user interface 90 in the truck of the cab or elsewhere. Further the controller may be programmed to receive user inputs from the user interface 90.

In addition, the controller includes programming that allows for calculating the mil thickness of the marking material applied to the roadway based on the inputs from the displacement or distance sensor 50 and the speed sensor 84. The controller may additionally utilize one or more inputs provided by a user and/or acquired from memory. That is, signals from a distance sensor and/or vehicle speed from a vehicle speed sensor 84 (e.g., displacement signals) may be input to a processor of the controller to calculate a real-time mil thickness of material being applied to a roadway surface. This may be output to the user interface 90. An operator may monitor the mil thickness and may increase or decrease the thickness as desired. That is, the use may provide an input to increase or decrease the applied mil thickness. The controller may receive such a user adjustment and generate a control output to adjust (e.g., increase or decrease) the speed of the hydraulic supply pump 29 thereby increasing or decreasing the speed of the paint pump 30. Such an increase or decrease in the speed of the paint pump alters the mil thickness of a paint line(s) subsequently applied to the surface.

In one embodiment, the controller 80 is operatively to alter the operation of the paint pump 30 (e.g., via control of the hydraulic pressure pump) to automatically maintain a desired line mil thickness. For example, the controller may calculate applied line mil thickness every five seconds. The controller may compare each calculated mil thickness to a predetermined or target thickness, which may be set by the operator. The controller may generate a control output to adjust the speed of the hydraulic pressure pump to adjust the speed of the of paint pump and thereby maintain the mil thickness of the applied roadway markings within a desired range.

The controller may provide various information and data to the operator. The data may include, but is not limited to, current material flow rate, accumulated gallons or pounds used, amount of material per pump stroke, material line pressure, and material temperature in addition to the mil thickness. The information may be displayed on any user interface. Further, the controller may store all date electronically for future reference and reports.

The foregoing description of the presented inventions has been presented for purposes of illustration and description. Furthermore, the description is not intended to limit the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed:

1. A system for calculating a thickness of a marking line applied to a surface as a paint vehicle moves over the surface, comprising:
a positive displacement pump that pumps paint from a paint supply tank to one or more paint guns;
a linear distance sensor disposed proximate to the pump and configured to:
measure positions of a shaft of the positive displacement pump while the positive displacement pump operates; and
generate position outputs of the position of the shaft;
a controller operatively connected to the linear distance sensor to receives the position outputs from the linear distance sensor and configured to:
calculate a volumetric displacement of the paint pump between a first measured position of the shaft and a second measured position of the shaft; and
generate a mil thickness of a paint line applied to a surface by the one or more paint guns for a time period corresponding to the first and second measured positions of the shaft.

2. The system of claim 1, further comprising a vehicle displacement sensor configured to generate speed outputs indicative of a speed or distance of the paint vehicle moving over the surface.

3. The system of claim 2, wherein the controller is operatively connected to the vehicle displacement sensor to receive the speed or distance outputs from the vehicle displacement sensor.

4. The system of claim 3, wherein the controller is further configured to:
utilize the speed or distance outputs to calculate the mil thickness of the paint line.

5. The system of claim 1, further comprising:
a user interface operatively connected to the controller, the user interface configured to output a display of the mil thickness.

6. The system of claim 5, wherein the user interface is further configured to receive user inputs to increase or decrease the mil thickness of the paint line applied to the surface.

7. The system of claim 6, wherein the controller is further configured to increase or decrease a speed of the paint pump to subsequently increase or decrease the mil thickness of a subsequently applied paint line.

8. The system of claim 1, wherein the controller is further configured to:
compare the mil thickness to a target mil thickness; and
increase or decrease a speed of the paint pump to adjust the mil thickness of a subsequently applied paint line to be within a desired range of the target mil thickness.

9. The system of claim 1, further comprising:
a linear hydraulic actuator connected to the shaft of the paint pump; and
a hydraulic pressure pump fluidly connected to the linear hydraulic actuator.

10. The system of claim 9, wherein the controller is further configured to:
generate control outputs to alter the speed of the hydraulic fluid pump.

11. A method for calculating a thickness of a marking line applied to a surface as a paint vehicle moves over the surface, comprising:
acquiring, from a linear distance sensor, at least first and second position measurements of a shaft of a positive displacement paint pump while the paint pump operates to apply paint to a surface over which the paint vehicle moves;
determining a volumetric displacement of the paint pump between first and second shaft positions corresponding with the first and second position measurements;
acquiring a vehicle displacement signal indicative of a speed or a distance traveled by the paint vehicle during a time period between the first and second position measurements; and
calculating a mil thickness of a paint line applied to the surface based on the volumetric displacement of the paint pump and the displacement signal; and
generating an output based on the mil thickness.

12. The method of claim 11, wherein acquiring the at least first and second position measurement comprises:
acquiring a position measurement at least once every five seconds.

13. The method of claim 11, wherein generating the output comprises:
outputting the mil thickness to a display of a user interface.

14. The method of claim 11, further comprising:
receiving, from the user interface, a user adjustment relative to the mil thickness output to the display; and
based on the user adjustment, increasing or decreasing a speed of the paint pump to increase or decrease a subsequent mil thickness of the paint line.

15. The method of claim 11, further comprising:
comparing the mil thickness to a target mil thickness; and
generating a control output to increase or decrease speed of the paint pump to increase or decrease a subsequent mil thickness of the paint line, wherein generating the output comprises generating the control output.

16. The method of claim 11, further comprising:
receiving a pump speed signal indicative of a speed of a hydraulic pressure pump that controls movement of a shaft of the paint pump; and
generating a control output to increase or decrease speed of the hydraulic pressure pump based on the mil thickness.
